(19) United States
(12) Patent Application Publication
(10) Pub. No.: US 2015/0291857 A1
(43) Pub. Date: Oct. 15, 2015

(54) BIO-BASED BINDER AND FIBERGLASS INSULATION

(71) Applicant: ECOSYNTHETIX LTD., Lansing, MI (US)

(72) Inventor: Uttam Kumar Saha, Thornhill (CA)

(21) Appl. No.: 14/418,313

(22) PCT Filed: Aug. 1, 2013
(86) PCT No.: PCT/US13/53209

§ 371 Date: Jan. 29, 2015

Related U.S. Application Data
(60) Provisional application No. 61/679,453, filed on Aug. 3, 2012.

(51) Int. Cl. C09J 103/02; C03C 25/32; C03C 25/28; C09J 129/04

(52) U.S. Cl. CPC C09J 103/02; C09J 129/04; C03C 25/321; C03C 25/28

(57) ABSTRACT

A curable aqueous binder has two primary components. The first component is a bio-based material or mixture of bio-based materials such as starch or polyvinyl alcohol. The second component is one or more compounds selected from the group of urea, polyurea and substituted urea. The first and second components make up most (i.e. 50% or more) of all solids in the binder. The dry weight of the second component is preferably 25% or more of the dry weight of the first component. The solids content of the binder is preferably between 6 wt % and 20 wt %. A method of making a mineral fiber product includes a step of curing a binder as described above in situ on a mass of mineral fibers at a temperature of 175 degrees C. or more. A preferred binder is a mixture of urea and starch in a ratio by weight between 50-50 and 80-20 in water at a solids content of 10-20 wt %, substantially without other components, and may be used as a replacement for formaldehyde or petrochemical based resins. The starch is preferably cooked, thermoplastic or nanoparticle starch.

### RELATED APPLICATION

This application claims the benefit under 35 USC 119 of, and priority to, U.S. Provisional Application 61/679,453, filed on Aug. 3, 2012, which is incorporated by reference.

### FIELD

This specification relates to bio-based binders and to fiberglass insulation.

### BACKGROUND

The following background discussion is not an admission that anything described below is common general knowledge of a person skilled in the art.

U.S. Pat. No. 4,014,726, Production of Glass Fiber Products, describes a method of making fiberglass insulation. The method includes steps of forming glass fibers from molten streams of glass, combining the glass fibers with a heat curable aqueous binder composition, consolidating the fibers and binder into a loosely packed mass on a foraminous conveyor, and curing the binder in situ on the glass fiber product. The primary component of the binder is a complex polymeric component formed by reacting phenol, formaldehyde, starch or degraded starch, and urea.

Urea formaldehyde, phenol formaldehyde and phenol urea formaldehyde have been traditionally used as binders in making fiber glass insulation. However, formaldehyde is has been classified by the International Agency for Research on Cancer as a known human carcinogen. Formaldehyde is also a volatile substance that can be emitted from manufacturing plants and into indoor air, particularly from urea-formaldehyde insulation products. Accordingly, while the U.S. Consumer Products Safety Commission has stated that fiberglass insulation products have little impact on free formaldehyde levels in homes, the insulation industry has been experimenting for several years with possible essentially formaldehyde free binders. For example, other polymers such as polyacrylic acid, polyvinyl acetate and polyester have been used to create formaldehyde free (alternatively called “no added formaldehyde”) binders. However, these polymers are expensive, release some volatile compounds, and in some cases their acidity can damage manufacturing equipment and metal structures being insulated.

The non-formaldehyde polymers mentioned above are also typically made from petroleum and so are subject to concerns over the long term price, availability and environmental impact of using petroleum derived products. Some attempts have therefore been made to produce binders that are not only formaldehyde free, but also include bio-based materials. Bio-based materials are typically derived from plants, or sometimes animals.

US Publication 20110021101, Modified Starch Based Binder, describes a binder for glass fibers including chemically modified starch, a silane coupling agent and, optionally, a cross-linking agent. The starch is modified by oxidation, bleaching, or acid or base treatment to have a degree of polymerization between 20 and 4000. The modified starch is water dispersible and has a reduced viscosity.

Japanese publication 11256477 describes a binder for glass fibers comprising starch that has been subjected to hydrolysis or cross linking. The starch is added with 2-10 wt % of urea (based on the weight of starch). The resulting starch esterified with carbamic acid compounded with additives such as a lubricant, a cationic softener, a surfactant and other additives.

U.S. Pat. No. 7,854,980, Formaldehyde-free Mineral Fibre Insulation Product describes, in one example, a binder made up of dextrose monohydrate, anhydrous citric acid, ammonia and a silane.

### INTRODUCTION

The following summary is intended to introduce the reader to the detailed description to follow and not to limit or define any claimed invention.

A binder is described in this specification comprising two components in water. The first component is a bio-based material or a mixture of bio-based materials. The bio-based material may optionally comprise biopolymer nanoparticles. The second component is one or more compounds selected from the group of urea, polyurea or substituted urea. In some examples, the two components are starch and urea. Collectively, the first and second components make up most (i.e. 50% or more) of the total solids in the binder. The dry weight of the second component is preferably at least as much as the dry weight of the first component and at least 25% of the total solids in the binder. The total solids content of the binder is preferably between 6 wt % and 25 wt %.

A method of making a fiberglass product is described in this specification. The method includes a step of curing a binder as described above in situ on a mass of glass fibers. The curing temperature may be 150 degrees C. or more or 175 degrees C. or more or 200 degrees C. or more or 225 degrees C. or more.

### DETAILED DESCRIPTION

Various binders, alternatively called resins or aqueous compositions, were developed for use, for example, in making fiberglass insulation. The binders might also be useful in other applications, but they are intended to have one or more characteristics that are similar to existing binders used in making fiberglass insulation. In this way, the binders may be used in existing plants for making fiberglass insulation with acceptable amounts of modification to the plant. Optionally, the binders are essentially formaldehyde free or at least have less than 1 wt % of the total solids as formaldehyde.

A typical mineral fiber insulation manufacturing process begins by melting the raw material such as glass pellets. In the hot end of the process, the melted raw material is converted into fibers while an aqueous binder is sprayed on the molten fibers such that a mixture of the fibers and binder is collected on a conveyor belt. The mass of fibers and binder travels on the conveyor through forming and compression devices to a curing oven. In a cool end of the process, the mixture of fibers and cured binder is cooled, shaped or cut, and packaged.

In order to be compatible with the spraying equipment, the binder should have a Brookfield viscosity of less than 500 cps, preferably about 250 cps or less, at a solids content that applies a sufficient amount of binder to the fibers. Conventional phenol urea formaldehyde binders have a solids content between about 6 wt % and about 20 wt %. The binder should also be stable as an emulsion or dispersion at the required solids content at least for the retention time of the spraying equipment.

The water in the binder partially cools the fibers. However, the binder may still be heated momentarily to as much as 150 degrees C. by contact with the molten fibers. The forming and compression steps are carried out at temperatures up to 75 degrees C. The curing step, however, is typically carried out at about 180 degrees C. or more, typically about 200 degrees C. Accordingly, the binder should have a curing temperature between 75 and 200 degrees C. but should also resist curing during the initially application to the molten fibers.

There are various performance requirements for insulation products but the most important are dry tensile strength and wet tensile strength. In addition to the absolute values of these strengths, the retention (wet tensile strength divided by dry tensile strength) is preferably 80 percent or more.

The exemplary binders to be described in more detail below have two components in water. The first component is a bio-based material or a mixture of bio-based materials. The second component enhances the wet strength of the binder and preferably cross-links the binder to the mineral fibers. The dry weight of the second component is preferably at least as much as the dry weight of the first component. The total solids content of the binder is preferably between 6 wt % and 25 wt %. The binders may be used in a process as described above and may be cured in situ on a mass of glass fibers. The curing temperature may be, for example, 175 degrees C. or more or 200 degrees C. or more, up to 225 degrees C. or up to 250 degrees C.

In the examples below, the two components make up 95% or more of the total solids in the binder. However, typical processing additives such as lubricants, softeners or surfactants might be added thus reducing the relative weight of the two components, for example to 75 wt % or more of the total solids in the binder, while the binder is still based on a single resin system made up primarily of the two components. The two primary components might also be blended with, or partially substituted for, a second binder system. The second binder system may be a non-formaldehyde but non-bio-based system such as a polyacrylic acid, polyvinyl alcohol, polyvinyl acetate, polyurethane and polyester resin system. However, the first and second compounds preferably make up most (i.e. 50 wt % or more) of the solids in the binder with the second component, for example urea, providing 20 wt % or more, or 25 wt % or more, of the total solids in the binder.

Small amounts of a second binder system can be used to increase the rigidity of fiberglass insulation, or other fibers being bound by the binder. For example, any one or more of the second binder systems mentioned above may be added to provide 0.5 wt % to 10 wt % of the total solids in the binder. Preferred second binder systems for increasing the rigidity of fiberglass insulation include polyvinyl alcohol (PVOH) and polyacrylic acid (PAA). Adding polyacrylic acid, or another acid, may also reduce the emission of ammonia when the binder is cured.

A supplemental crosslinker (in addition to any crosslinker within particles of the first component and the second component) may also be added to the binder. The crosslinker may include one or more crosslinkers selected from the group consisting of dialdehydes, polyaldehydes, acid anhydrides or mixed anhydrides, (e.g. succinic and maleic anhydride), glutaraldehyde, glyoxal, oxidized carbohydrates, periodate-oxidized carbohydrates, epichlorohydrin, epoxides, triphosphates, petroleum-based monomeric, oligomeric and polymeric crosslinkers, biopolymer crosslinkers, divinyl sulphone, borax (e.g. Na₂B₄O₇.5H₂O or Na₂B₄O₇.10H₂O, isocyanates, polyacids and hydrolyzable organo alkoxy silanes producing silanols. The crosslinking reaction may be acid-catalyzed or base-catalyzed. Suitable dialdehydes and polyaldehydes include glutaraldehyde, glyoxal, periodate-oxidized carbohydrates, and the like. Polyacids may be organic or inorganic, including nonpolymeric polyacids such as citric acid, maleic acid, succinic acid, phthalic acid, glutaric acid, malic acid, oxalic acid or the like, and salts or anhydrides thereof. Glyoxal, borax, epichlorohydrin, isocyanates, anhydrides, polyacids and silicates such as tetraethyl orthosilicate (TEOS) are particularly suitable crosslinkers. Citric acid in particular is inexpensive and bio-based and may help reduce ammonia emissions on curing the binder. The amount of crosslinker can be, for example, between 0.1 and 10 wt % of the total solids in the binder.

The bio-based material may be, for example, one or more biopolymers or other hydroxylated polymers. Suitable biopolymer materials may include, for example, natural and modified starches; other carbohydrate or polysaccharide polymers such as cellulose, hemi-cellulose, gums and dextrin; lignin; soya, whey, gelatin or other proteins; and, dry distillery grains. Suitable hydroxylated bio-based polymers may include, for example, polyvinyl alcohol; and, natural polyol. Less preferably, some of the compounds mentioned above may also be produced synthetically and used in the binder.

In the examples below, the first component is a processed biopolymer, particularly starch. The processing decreases the viscosity of the biopolymer and makes it more readily dispersible in water. For example, the processing may be a thermal process such as cooking, a thermo-mechanical process such as extrusion, or a process to produce biopolymer nanoparticles. These processes do not require the use of biopolymers that have been chemically modified before the processing. Alternatively, a chemical process to produce cold soluble (dispersible) starch might also be used alone or in combination with another process described in this paragraph. The biopolymer may be prepared with or without a crosslinking or other reagent or modification process.

The term biopolymer nanoparticle will be used in this specification to refer to a form of a biopolymer in which the native structure of the biopolymer source material has been substantially removed but multiple molecules of the bio-polymer are complexed to form discrete particles, for example by way of cross-links between molecules within the particles. The adjective “nano” is meant to include collections, for example colloids, dispersions or powder of biopolymer particles having an average size of 2500 nm or less, preferably 1000 nm or less. The average size may be measured either as the volume or number average of a dynamic light scattering (DLG) measurement or the D50 value of a nanoparticle tracking analysis (NTA) measurement.

A preferred process for making biopolymer nanoparticles is by reactive extrusion, for example as described in U.S. Pat. No. 6,677,386, which corresponds with International Publication WO 00/69916. Some other processes said to produce biopolymer nanoparticles are described in Starch nanoparticle formation via reactive extrusion and related mechanism study, Song et. al., Carbohydrate Polymers 85 (2011) 208-214; US Publication 20110042841; International Publication Number WO 2011/071742; International Publication Number WO 2011/155979; U.S. Pat. No. 6,755,915; International Publication 2010/084088; and, International Publication WO 2010/065750.

Alternatively, fragmented particles may be used. British patent GB 1420392, for example, describes a method of producing fragmented starch particles that are partially cross-linked and partially crystalline or soluble that may be used as an alternative to nanoparticles. Nanoparticles are preferred, however, since they are likely to have lower viscosity and to be less prone to retrogradation.

The presence of biopolymer nanoparticles can be determined by observation under a scanning electron microscope (SEM); detecting particle sizes larger than individual molecules by DLS or NTA measurements; or, observing a maximum swelling value (alternatively called a volume factor or swell ratio) in a very dilute dispersion of the biopolymer nanoparticles that is less than the swell ratio of the native or dissolved form of the biopolymer. Regarding the last technique, the swell ratio of native starch granules is about 32 and the swell ratio of cooked (dissolved) starch is about 44. In comparison, the swell ratio of starch nanoparticles may be between about 2 and 20 with lower swell ratios corresponding to more tightly cross-linked particles. A method of determining swell ratio is described in International Application No. PCT/CA2012/050375 which is incorporated herein by this reference to it.

A preferred method of thermo-mechanically processing starch is extrusion at a temperature of 100 degrees C. or more, preferably at 150 to 200 degrees C., and a specific mechanical energy of at least 100 J per g of biopolymer, preferably at least 400 J per g. The crystalline structure of the native starch grain is substantially removed in the extruder. The extrusion process may be a reactive extrusion process used to produce biopolymer nanoparticles, as described for example in U.S. Pat. No. 6,677,386, which is incorporated herein by this reference to it. Alternatively, the extrusion process may produce thermoplastic starch which does not necessarily contain nanoparticles. However, nanoparticles may be prepared in a factory and sent as a dry powder to be mixed at the fiberglass manufacturing plant with urea powder and water. This may provide a practical advantage over cooked or thermoplastic for some, although not necessarily all, fiberglass manufacturing plants.

In thermo-mechanical processing, the use of plasticizers other than water, for example glycerol, appears to reduce the tensile strength of the cured binder and so should be avoided. Further, it appears that adding large amounts of cross-linker during extrusion so as to produce nanoparticles with a swell ratio of is less than about 15 may also reduce the wet tensile strength of the cured binder. Adding smaller amounts of cross-linker may also cause a reduction in wet tensile strength but the reduction appears to be minimal and the resulting product is easier to produce and handle than samples made with minimal cross-linker or, in the case of waxy corn starch, without any added cross-linker. Further, product with a swell ratio less than about 18 is likely to remain in dispersion for a longer period of time, retrograde more slowly and be less viscous at high shear rates than ordinary thermoplastic or cooked starch or starch nanoparticles with higher swell ratios.

Some spraying equipment in fiberglass manufacturing plants may have significant residence times, for example 72 hours or more, and have small diameter, high pressure, nozzles which generate high shear. In these applications in particular, the addition of a cross-linker in the extruder to ensure formation of nanoparticles may be beneficial. However, as indicated in the examples below, cooked or thermoplastic starch also produce useful binders that might be preferred in some manufacturing environments.

Waxy corn starch is a preferred bio-based material due to its resistance to retrograding after it has been processed relative to other starches. This resistance is particularly important when the starch is processed by cooking or to produce thermoplastic starch. Waxy corn starch also produces nanoparticles with less cross-linker or without added cross-linker. However, resistance to retrogradation is less important when using a processing method that produce nanoparticles or bio-based materials that do not degrade in a manner similar to cooked starch.

The second component in the examples below is urea, alternatively called carbamide. The urea is free urea, meaning in particular that the urea has not already been reacted with formaldehyde and, if there is any un-reacted formaldehyde in the binder, that the urea is in excess of any urea that would react with formaldehyde in the binder. The free urea is used as an active binder agreement to combine with the bio-based material or materials and not to scavenge formaldehyde.

It appears from the results described below that starch and urea; or, starch, urea and glass fibers, react at sufficiently high temperatures at least when excess water is evaporated from the binder. Without intending to be limited by theory, starch and glass fiber may bind together through urea as a cross-link. The cross-link may involve the hydroxyl group of the starch. The cross-link may also involve eliminating two water molecules and urea forming cyclic urea to make hydrophobic starch/cyclic urea which binds with glass fiber through a hydrogen bond. The reaction might occur through the mechanism shown below.

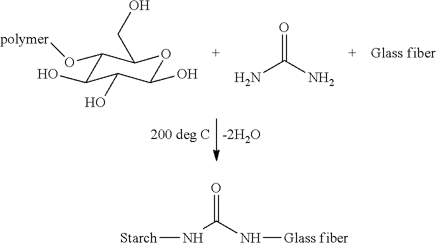

Alternatively, it is possible that urea degrades at 150 to 170 degrees C. to form ammonia and cyanic acid, or isocyanic acid. Isocyanic acid may react with hydroxyl groups on the starch and the glass fiber and produce urethane, or urethane groups which have strong adhesive properties.

Although urea is used in the examples below, it can be expected that related compounds such as polyurea or any substituted urea, cyclic or acyclic, may be used. Urea, used substantially alone, is preferred however based on its performance (to be described below), availability and substantial lack of toxicity. Urea is produced in the body and degrades to ammonia, which is also not harmful in moderate concentrations. While most commercially available urea is produced from synthetic ammonia derived from coal or natural gas, it is possible to produce urea from bio-based ammonia extracted from wastewater treatment plants or converted from biogas.

In the examples below, the samples are cured at 200 degrees C. for 10 minutes. Other samples were successfully cured at 175, 225 and 250 degrees C. Dry and wet strength increased with curing temperature from 175 degrees C. to 225 degrees C. At 250 degree C. the glass fiber paper used in the tests turned brown. The preferred temperature range for curing a starch and urea mixture in typical conditions in a fiberglass manufacturing plant is believed to be about 175 to 250 degrees C. Tests at room temperature for 3 days and at 100 and 150 degrees C. for 10 minutes failed to produce a complete cure. However, the samples tested at 100 and 150 degrees C. were significantly heavier than samples cured at 200 degrees C. The higher weight indicates that less water was driven out of the samples tested at the lower temperatures. It is not clear whether the retained water was due to a lack of sufficient time and/or temperature to cure or a lack of sufficient time to evaporate free water. Curing a composition having a mixture of urea and starch at a ratio of 65-35 and 15 wt % total solids at 150 degrees C. resulted in an LOI similar to curing the same composition at 200 degrees C. for 10 minutes, but the sample cured at 150 degrees C. for 60 minutes still had significantly lower wet strength (5.7 N for sample cured at 200 degrees C. for 10 minutes; 3.8 N for sample cured at 150 degrees C. for 60 minutes) suggesting that 150 degrees C. per might not be able to produce a complete cure.

The second component may be added before or after processing the first component. However, there does not appear to be any improvement in the final product resulting from adding the second component before processing the first component. On the contrary, adding the second component before processing the first component can cause processing difficulties because urea melts at 133 degrees C. and produces ammonia in water at a concentration that increases with temperature. In extrusion processing, excess water must be added to reduce extruder barrel temperatures and inhibit ammonia formation. Even with excess water, extruding a binder with 11 wt % urea based on the weight of starch in this trial produced a noticeable ammonia smell and this binder did not provide acceptable tensile strength. When cooking starch, it is possible to use 25-95 wt %, for example 50 wt %, of the total solids as urea at least when the temperature is kept below about 98 degrees C.

Extrusion processed starch is shown, in the examples below, to produce lower viscosities at the same total solids content than cooked starch. Based on values reported in US Publication 20110021101, extrusion processed starch also appears to have lower viscosities at the same solids content than chemically modified water dispersible starch. Mixtures of 40-60 or 50-50 urea-extruded starch to 80-20 or 90-10 urea-extruded starch at 15 wt % total solids produced viscosities similar to a comparative phenol urea formaldehyde (PUF) resin at 10 wt % total solids. This additional solids content without increase in viscosity usefully allows the tensile strength of products bonded with the starch-urea binder to meet or exceed the strength of the comparative PUF resin. One specific example of a binder for replacing this reference PUF resin consists essentially of a mixture of 65-35 urea-extruded starch at 15 wt % total solids in water optionally with a starch produced with some added cross linker to reduce the swell ratio of the crosslinked starch (as a pure dispersion in water) to between 14 and 18. Adding up to 10 wt % of a crosslinker, or up to 10 wt % of a secondary binder system, or both, provides strength comparable to PUF resin at comparable loss on ignition (LOI) even when the second component is reduced to 40 wt % or less, for example 20 wt % to 40 wt %, of the total solids in the binder with the remainder of the binder optionally consisting essentially of the first component, or when the second component is reduced to 50 wt % or less of the weight of the first component. It can be expected that values within 20%, plus or minus, of the values given immediately above would also produce similarly useful results. Binders within other ranges described in this specification are also useful and may be preferred if another mix of characteristics is required in a particular application.

### Examples

Samples of thermo-mechanically processed waxy corn starch were produced in a twin screw extruder generally as described in U.S. Pat. No. 6,677,386 and International Publication Number WO 2010/065750. Native starch containing a maximum of 14% water was fed into the extruder through a feeder at a rate of 300 kg per hour. The amount of water added was from 15 to 50 parts per hundred of dry starch. An aqueous solution of crosslinker (40% in water), if any, was fed through a liquid feeder at a rate of 0-2.5 parts per hundred of dry starch. The temperature at the end barrel was typically 180 degree Celsius. The SME applied in the extruder was at least 800 J/g. The end point pressure was from 1 to 60 bar. The extruded material was collected manually, dried at 20-25 degrees C. and atmospheric pressure and grinded to produce a powder that could be re-dispersed with urea powder in water to produce binders in various ratios of starch to urea and total solids contents.

The samples of thermo-mechanically processed starch in 25 wt % dispersion were observed under a microscope (Olympus BX51) under normal and polarized light. These observations confirmed that there was essentially no crystalline structure in the starch.

Unless noted otherwise, samples were extruded without added cross-linker. However, waxy corn starch forms nanoparticles more readily than other forms of starch and it is possible that the source material contained traces of compounds that contributed to cross-linking. To determine whether nanoparticles had been formed, the particle size of the samples was measured by NTA using a 0.0025 wt % dispersion of the sample and a Nanosight LM20 instrument. Nanoparticles were detected having sizes of 100-600 nm. The presence of particles was also confirmed by swell measurements which measured a swell ratio of 18.5. Additional samples were prepared with added cross-linker. The particle size of these samples was lower, between 30 and 500 nm, and the swell ratios were reduced to 15.2 and 14.5.

Samples of cooked starch and urea were produced by first mixing dry starch and urea powder in various ratios. 100 g of the powder mixture was slowly added to 300 g of water at room temperature (20-25 deg C) while stirring vigorously. The final mixture was poured into a starch cooker and cooked at 95-98 degrees C. for 20-60 minutes. The cooked urea-starch mixtures were diluted with water to produce binders at various total solids contents.

Viscosity measurements were made by placing binder samples in a 225 ml plastic beaker. The temperature of each sample was adjusted to between 20 and 25 degrees C. Viscosity was measured using a Brookfield RVDV-II+P Viscometer at 100 rpm.

Tensile strength and pick up measurements were made using 15×17 cm sheets of blank glass fiber filter paper. Each sheet was first weighed (W₁) and then soaked in a tray of the sample binder for 5 minutes. The soaked paper was hung until excess binder stopped dripping from the sheet. The wet sheets were placed in an oven at 200 degree C. for 10 minutes. After 10 minutes, the cured glass fiber sheet was taken out and weighed (W₂) at room temperature. The weight difference of W₂-W₁ was recorded as the binder pick-up. The sheet was then cut into twelve equal pieces. Six pieces were used for dry tensile strength measurements by pulling them until tearing on an Instron 3365 instrument. The remaining six pieces were soaked in water at 80 degree Celsius for 5 minutes. Excess water was removed from the soaked pieces using a dry paper towel. The moist pieces were then used for wet tensile strength measurements by pulling them until tearing on the Instron 3365 instrument.

Comparative binders using non bio-based materials were also prepared and measured for viscosity, tensile strength and pick up using the procedures described above.

In some cases, loss on ignition (LOI) data was generated instead of pick up data. LOI data was determined by subtracting the weight of a sample after heating at 550 degrees C. for 5 minutes to remove the binder from the weight of the same sample after it was cured, and dividing this numerator by the weight of the same sample after it was cured. LOI measurements may vary slightly with the weight of the sample sheet before adding the binder but a series of tests using a mixture of urea-starch in a 65-35 ratio at different solids contents determined that pick up and LOI are generally proportional to each other over a range of LOI from about 20% to about 35% and that an LOI of 25% corresponds to a pick up of about 0.6 g per sample. Further, wet strength of these samples was generally proportional to LOI such that a ratio of wet tensile strength divided by LOI appears to be an acceptable means of comparing data at different LOI amounts. Dry strength also appears to be generally proportional to LOI but along a line that would not pass as closely to the intersection of the axes on a graph of dry strength and LOI. The paper samples tested are not mechanically the same as fiberglass insulation but have been used in the fiberglass industry to compare binders, particularly when LOI is at, or can be adjusted to, 25% or less.

In two initial tests, an extrusion process was used in which 11 to 15 parts of water per hundred of dry starch and 6 and 11 parts of urea per hundred of dry starch were added to the extruder. The temperature range at the end barrel was from 179 to 192 degree Celsius. The end point pressure was from 9 to 16 bars. Binder samples were produced at 10 wt % solids concentrations. The dry tensile strength of the 6 wt % (relative to starch) urea sample was 3.4 N and its wet tensile strength was 0.5 N. The dry tensile strength of the 11 wt % (relative to starch) urea sample was 4.4 N and its wet tensile strength was 1.1 N. Both of these samples were deemed to have insufficient wet tensile strength for use in fiberglass insulation.

Various comparative and experimental binders were tested with results as described in Tables 1 and 2 below.

As indicated in Table 1, samples with 30 wt % (of the total solids) as urea and very low solids contents did not have sufficient wet strength. However, some of the cooked starch samples (particularly 50-50 urea-starch cooked for 30 minutes) were able to combine acceptable viscosity with wet strength comparable to the reference polyvinyl acetate sample at solids contents of 10 wt %. Although thermoplastic (non-biopolymer) starch was not produced in the extruded samples, thermoplastic starch would have a structure similar to cooked starch and so can be expected to produce similar results. The samples with 50-50 urea-extruded starch had significantly reduced viscosity even at higher total solids contents of 15 and 20 wt %. These higher solids content samples also had wet strength comparable to the reference sample. The low viscosity of the extruded starch samples indicates that binders with higher total solids contents, for example up to 25%, may still have acceptable viscosity.

As indicated in Table 2, mixtures from 40-60 or 50-50 to 80-20 or 90-10 urea-starch produced wet tensile strengths comparable to the reference standard with mixtures in the range of 60-40 to 70-30 urea-starch producing the most wet tensile strength. Adding a cross-linker to the extruder caused a small reduction in wet tensile strength relative to samples at the same wt % of urea, but wet tensile strength was still comparable to the reference standard.

In further tests, a PUF resin at 10% total solids was compared to (a) a binder made of 65-25-10 urea-extruded starch at a swell factor of 15.2-polyvinyl alcohol at 15 wt % total solids; b) a binder made of 65-25-10 urea-extruded starch at a swell factor of 15.2-polyvinyl alcohol at 10 wt % total solids; and, c) a binder made of 65-25-10 urea-extruded starch at a swell factor of 15.2-polyol at 15 wt % total solids with 0.15 g of sodium dodcylsulfate (SDS) added to help solbilize the polyol in water. The PUF resin had a dry strength of 5.2 N, a wet strength of 4.3 N and an LOI of 36%. Binder a) had a dry strength of 8.7 N, a wet strength of 5.2 N and an LOI of 33%. Binder b) had a dry strength of 6.7 N, a wet strength of 4.4 N and an LOI of 23%. Binder c) had a dry strength of 6.1 N and a wet strength of 4.7 N. Further samples with PVA replacing all of the starch were tested with results as described in Table 3 and also provided acceptable results.

Tables 4 and 5 describe the results of further tests using starch extruded with cross-linker to a swell factor of 15.2 in various compositions with urea at the blend ratios and solids contents indicated. In some of these tests, the amount of urea was reduced below 50 wt % relative to the weight of the solids. As indicated in Tables 4 and 5, samples with less than 50 wt % urea relative to the weight of the solids (i.e. 10/90 urea/starch to 40/60 urea/starch) had low wet strengths despite their high LOI. When a ratio of wet tensile strength divided by LOI is considered, blends from about 40/60 urea/starch or 50/50 urea/starch are comparable to PUF resin whereas blends with less urea are not.

TABLE 1

| | | Dry strength | Wet strength | Pick-up |
|---|---|---|---|---|
| Sample | viscosity in cps | in N | in N | in gram |
| 30-70 (urea-waxy 30 min cook) | 450 (10% solid) | 7.1 | 3.3 | 1.22 |
| 50-50 (urea-waxy 30 min cook) | 440 (10% solid) | 6.9 | 4.6 | 0.92 |
| 30-70 (urea-waxy 60 min cook) | 120 (5% solid) | 4 | 2.1 | 0.52 |
| 50-50 (urea-waxy 60 min cook) | 64, 62 (5% solid) | 4.09, 4.3 | 2.5, 2.15 | 0.33, 0.38 |
| 50-50 (urea-waxy cooked with urea | 73 (5% solid) | 3.9 | 2.4 | 0.38 |
| after cooking and cooling to room | | | | |
| temperature) | | | | |
| 100% cooked waxy starch | 347 (5% solid) | 5.1 | 0.5 | 0.78 |
| 50-50 (urea-waxy 60 min cook) | 173 (7.5% solid) | 6 | 2.85 | 0.61 |
| 50-50 (urea-waxy 60 min cook) | 318 (10% solid) | 6.3 | 3.8 | 0.99 |
| 50-50 (urea-extruded waxy) | 33 (10% solid) | 5.4 | 2.75 | 0.59 |
| 50-50 (urea-extruded waxy) | 49 (15% solid) | 6.15 | 4.3 | 1.09 |
| 50-50 (urea-extruded waxy) | 82 (20% solid) | 8.6 | 5.05 | 1.5 |
| 50-50 (urea-extruded waxy) | 146 (25% solid) | 9.6 | 5.85 | 2.2 |
| Polyvinyl acetate (comparative | 12 (10% solid) | 4.74 | 4.66 | 0.93 |
| reference) | | | | |

TABLE 2

| | | Dry strength | Wet strength | Pick-up |
|---|---|---|---|---|
| Sample | Viscosity in cps | in N | in N | in gram |
| Polyvinyl acetate | 30 (10% solid) | 4.74 | 4.66 | 0.93 |
| (comparative reference) | | | | |
| 50-50 (urea-waxy extruded) | 49 (15% solid) | 6.15 | 4.3 | 1.09 |
| 60-40 (urea-waxy extruded) | <30, 15% solid | 6.1, 7.06 | 4.7, 4.97 | 0.91, 0.89 |
| 65-35 (urea-waxy extruded) | <30, 15% solid | 6.5 | 5 | 0.8 |
| 70-30 (urea-waxy extruded) | <30, 15% solid | 5.9. 5.97 | 4.6, 4.65 | 0.72 |
| 75-25 (urea-waxy extruded) | <30, 15% solid | 5.57 | 4.34 | 0.59, 0.67 |
| 80-20 (urea-waxy extruded) | <30, 15% solid | 5.7 | 4.2 | 0.52 |
| 90-10 (urea-waxy extruded) | <30, 15% solid | 5 | 3.6 | 0.43 |
| 100-00 (urea-waxy extruded) | <30, 15% solid | 1.8 | 0.8 | 0.34 |
| Phenol urea formaldehyde | <30, 10% solid | 5.7, 5.76 | 4.23, 4.34 | 0.99, 0.84 |
| (comparative reference) | | | | |
| 60-40 (urea-waxy extruded | <30, 15% solid | 5.9 | 4.13 | 0.85 |
| with crosslink to swell factor 15.2) | | | | |
| 65-35 (urea-waxy extruded | <30, 15% solid | 6.3 | 4.5 | 0.9 |
| with crosslink to swell factor 15.2) | | | | |
| 65-35 (urea-waxy extruded | <30, 15% solid | 6.3 | 4.3 | 0.86 |
| with crosslink to swell factor 14.5) | | | | |

TABLE 3

| | Average Dry | Average Wet | Average |
|---|---|---|---|
| Sample | strength N | Strength N | LOI % |
| 50/50 urea/PVA (10% solid) | 9.78 | 4.57 | 31.3 |
| 60/40 urea/PVA (10% solid) | 8.09 | 4.71 | 28.38 |
| 70/30 urea/PVA (10% solid) | 8.43 | 4.88 | 22.5 |
| PUF resin (10% solid) | 7.18 | 5.44 | 36.6 |

TABLE 4

| Varying Urea/ | Average Dry | Average Wet | Average |
|---|---|---|---|
| Starch Ratios | strength N | strength N | LOI % |
| (10:90) Urea-Starch (15% solid) | 11.33 | 3.09 | 58.28 |
| (20:80) Urea-Starch (15% solid) | 10.95 | 3.15 | 49.28 |
| (30:70) Urea-Starch (15% solid) | 9.8 | 4.37 | 44.91 |
| (40:60) Urea-Starch (15% solid) | 9.31 | 5.29 | 42.82 |
| (50:50) Urea-Starch (15% solid) | 9.11 | 5.75 | 38.75 |
| (65:35) Urea-Starch (15% solid) | 8.47 | 5.7 | 35.95 |
| PUF (10% solid) | 6.25 | 5.96 | 33.3 |
| (Comparative reference) | | | |

TABLE 5

| | Average Dry | Average Wet | Average |
|---|---|---|---|
| Sample | strength N | Strength N | LOI % |
| 10/90 urea/Starch (10% solid) | 7.19 | 1.66 | 40.86 |
| 15/85 urea/Starch (10% solid) | 6.83 | 1.88 | 40.49 |
| 20/80 urea/Starch (10% solid) | 7.44 | 2.51 | 38.71 |
| 25/75 urea/Starch (10% solid) | 7.53 | 2.87 | 36.98 |
| 30/70 urea/Starch (10% solid) | 7.33 | 2.87 | 35.49 |
| 40/60 urea/Starch (10% solid) | 7.16 | 3.57 | 32.26 |
| 50/50 urea/Starch (10% solid) | 6.7 | 3.9 | 27.94 |
| 60/40 urea/Starch (10% solid) | 6.11 | 4.05 | 23.42 |
| 65/35 urea/Starch (10% solid) | 6.41 | 4.23 | 22.51 |
| 70/30 urea/Starch (10% solid) | 5.79 | 3.79 | 21.76 |
| PUF resin (10% solid) | 7.18 | 5.44 | 36.6 |
| (Comparative reference) | | | |
| PUF resin (7% solid) | 6.39 | 4.9 | 28.3 |
| (Comparative reference) | | | |
| PUF resin (5% solid) | 4.67 | 3.25 | 19.15 |
| (Comparative reference) | | | |

1. (canceled)

2. (canceled)

3. (canceled)

4. (canceled)

5. (canceled)

6. (canceled)

7. (canceled)

8. (canceled)

8. (canceled)

9. (canceled)

10. (canceled)

11. (canceled)

12. (canceled)

13. (canceled)

14. (canceled)

15. (canceled)

16. (canceled)

17. (canceled)

18. An aqueous binder comprising,
a) a first component consisting of a bio-based material or a mixture of bio-based materials; and,
b) a second component consisting of one or more compounds selected from the group of urea, polyurea and substituted urea,
wherein,
c) the free dry weight of the second component is at least about 50% of the dry weight of the first component; and,
d) the bio-based material or materials are selected from the group of i) cooked starch; ii) thermoplastic starch; iii) thermo-mechanically processed starch iv) biopolymer nanoparticles, and, v) polyvinyl alcohol.

19. The aqueous binder of claim 18 wherein the free dry weight of the second component is at least as much as the dry weight of the first component;

20. The aqueous binder of claim 18 wherein the second component comprises urea in an amount that is at least 20% or 25% of the total solids in the binder.

21. The aqueous binder of claim 18 wherein the first component comprises cooked starch or thermo-mechanically processed starch.

22. The aqueous binder of claim 18 wherein the first component comprises starch nanoparticles.

23. The aqueous binder of claim 22 wherein the starch nanoparticles have an average particle size of less than 1000 nm when measured as the volume or number average of a dynamic light scattering measurement or the D50 value of a nanoparticle tracking analysis measurement.

24. The aqueous binder of claim 18 wherein the first component comprises starch having a swell ratio of about 10 or more, preferably about 14.5 or more.

25. The aqueous binder of claim 18 wherein the starch is waxy corn starch.

26. The aqueous binder of claim 18 having less than 1 wt % of formaldehyde on a dried solids basis.

27. An aqueous binder comprising (a) cooked starch or thermo-mechanically processed starch and (b) urea, polyurea or substituted urea, wherein parts a) and b) make up 75 wt % of more of the total solids in the binder.

28. The aqueous binder of claim 27 wherein the starch is waxy corn starch.

29. The aqueous binder of claim 27 comprising starch nanoparticles.

30. A method of making a mineral fiber product comprising a step of curing a binder according to claim 18 above in situ on a mass of mineral fibers.

31. The method of claim 31 wherein the binder is cured at a temperature of 175 degrees C. or more or 200 degrees C. or more.
